(19) United States
(12) Patent Application Publication
(10) Pub. No.: US 2026/0030335 A1
(43) Pub. Date: Jan. 29, 2026

(54) DATA PROCESSING

(71) Applicant: Tencent Technology (Shenzhen) Company Limited, Shenzhen (CN)

(72) Inventors: Shaoming WANG, Shenzhen (CN); Jinkun HOU, Shenzhen (CN); Runzeng GUO, Shenzhen (CN)

(73) Assignee: Tencent Technology (Shenzhen) Company Limited, Shenzhen (CN)

(21) Appl. No.: 19/344,127

(22) Filed: Sep. 29, 2025

Related U.S. Application Data
(63) Continuation of application No. PCT/CN2024/097246, filed on Jun. 4, 2024.

(30) Foreign Application Priority Data
Jun. 13, 2023 (CN) 202310700650.6

(51) Int. Cl. G06F 21/32; G06F 21/60; G06Q 20/40

(52) U.S. Cl. CPC G06F 21/32; G06F 21/604; G06Q 20/40145; G06Q 20/405

(57) ABSTRACT

In a computer-implemented method for managing a permission level of a user in a service scenario, biometric data of the user is acquired. The biometric data is collected in the service scenario. Identity recognition is performed on the user based on the biometric data to obtain a recognition result. A first permission level associated with the user in the service scenario is obtained. The first permission level is adjusted based on the recognition result to generate a second permission level. The second permission level is different from the first permission level. A second permission limit associated with the second permission level is different from a first permission limit associated with the first permission level. Apparatus and non-transitory computer-readable storage medium counterpart embodiments are also contemplated.

### RELATED APPLICATIONS

The present application is a continuation of International Application No. PCT/CN2024/097246, filed on Jun. 4, 2024, which claims priority to Chinese Patent Application No. 202310700650.6, filed on Jun. 13, 2023. The entire disclosure of the prior applications are hereby incorporated by reference.

### FIELD OF THE TECHNOLOGY

This application relates to the field of computer technologies, including a data processing method, a data processing apparatus, a computer device, a computer-readable storage medium, and a computer program product.

### BACKGROUND OF THE DISCLOSURE

In various service scenarios such as a payment scenario, an access control scenario, and a gaming scenario, a large number of service requirements are usually involved (for example, an asset payment requirement in the payment scenario and a door-opening requirement in the access control scenario). A large number of service requirements are accompanied by a large number of data interactions. Therefore, to avoid abnormal data interactions such as malicious transactions of a user, a corresponding risk control policy needs to be set in the service scenarios.

Currently, adjustment of the risk control policy in the service scenarios usually needs to be manually applied, and a corresponding application manner needs to be found to initiate an application for the risk control policy, which is not flexible enough.

### SUMMARY

Aspects of this disclosure provide a data processing method and apparatus, a computer device, a storage medium, and a product, which can adjust a level of a credit indicator of a user in a service scenario, thereby flexibly adjusting a risk control policy of the user in the service scenario.

According to an aspect of the disclosure, a computer-implemented method is for managing a permission level of a user in a service scenario is provided. In the method, biometric data of the user is acquired. The biometric data is collected in the service scenario. Identity recognition is performed on the user based on the biometric data to obtain a recognition result. A first permission level associated with the user in the service scenario is obtained. The first permission level is adjusted based on the recognition result to generate a second permission level. The second permission level is different from the first permission level. A second permission limit associated with the second permission level is different from a first permission limit associated with the first permission level.

According to an aspect of the disclosure, a data processing apparatus is provided. The data processing apparatus includes processing circuitry configured to acquire biometric data of a user. The biometric data is collected in a service scenario. The processing circuitry is configured to perform identity recognition on the user based on the biometric data to obtain a recognition result. The processing circuitry is configured to obtain a first permission level associated with the user in the service scenario. The processing circuitry is configured to adjust the first permission level based on the recognition result to generate a second permission level. The second permission level is different from the first permission level. A second permission limit associated with the second permission level is different from a first permission limit associated with the first permission level.

According to an aspect of the disclosure, a non-transitory computer-readable storage medium is disclosed. The non-transitory computer-readable storage medium stores instructions which, when executed by at least one processor, cause the processor to perform any of the data processing method described herein.

According to an aspect of the disclosure, the method includes: obtaining biological recognition data collected for a preset object in a service scenario; performing identity recognition on the preset object based on the biological recognition data, to obtain a recognition result of the preset object; and obtaining a first credit indicator in the service scenario corresponding to the preset object, and performing level adjustment on the first credit indicator based on the recognition result, to obtain a second credit indicator, the second credit indicator being different from the first credit indicator, and in the service scenario, a risk control policy associated with the second credit indicator being different from a risk control policy associated with the first credit indicator.

According to an aspect, this disclosure provides a data processing apparatus, the apparatus including: an obtaining unit, configured to obtain biological recognition data collected for a preset object in a service scenario; and a processing unit, configured to perform identity recognition on the preset object based on the biological recognition data, to obtain a recognition result of the preset object. The processing unit is further configured to: obtain a first credit indicator in the service scenario corresponding to the preset object, and perform level adjustment on the first credit indicator based on the recognition result, to obtain a second credit indicator, the second credit indicator being different from the first credit indicator, and in the service scenario, a risk control policy associated with the second credit indicator being different from a risk control policy associated with the first credit indicator.

According to an aspect, this disclosure provides a computer device, including a memory and a processor, the memory having a computer program stored therein, the computer program, when executed by the processor, causing the processor to perform any of the data processing methods described herein.

According to an aspect, this disclosure provides a non-transitory computer-readable storage medium, having a computer program stored therein, the computer program, storing instructions which when executed by a processor, cause the processor to perform any of the data processing methods described herein.

According to an aspect, this disclosure provides a computer program product or a computer program, the computer program product or the computer program including a computer instruction, the computer instruction being stored in a computer-readable storage medium. A processor of a computer device reads the computer instruction from the computer-readable storage medium, and the processor executes the computer instruction, so that the computer device performs any of the data processing methods described herein.

In the aspects of this disclosure, the biological recognition data collected for the preset object in the service scenario is obtained, so that identity recognition can be performed on the preset object based on the biological recognition data, to obtain the recognition result of the preset object. Because an identity recognition requirement is usually related to a specific service scenario, in this disclosure, identity recognition can be performed on a current user based on biological recognition data of the user in a specific service scenario (such as a payment scenario, an access control scenario, or a gaming scenario), thereby improving scenario adaptation of the identity recognition. A first credit indicator in the service scenario corresponding to the preset object is obtained, and level adjustment is performed on the first credit indicator based on the recognition result, to obtain a second credit indicator, the second credit indicator being different from the first credit indicator, and a risk control policy associated with the second credit indicator being different from a risk control policy associated with the first credit indicator. It can be seen from the above that in this disclosure, the identity recognition may be performed on the user in the service scenario, and the credit indicator of the user is flexibly adjusted based on the recognition result, so that as the credit indicator of the user changes (i.e., changes from the first credit indicator to the second credit indicator), the risk control policy for the user also changes accordingly. Therefore, in this disclosure, a corresponding risk control policy may be flexibly adjusted based on an indicator adjustment manner in a specific service scenario.

### BRIEF DESCRIPTION OF THE DRAWINGS

FIG. 1 is a schematic architectural diagram of a data processing system according to an aspect of this disclosure.

FIG. 2 is a schematic architectural diagram of a data processing scenario according to an aspect of this disclosure.

FIG. 3 is a schematic flowchart of a data processing method according to an aspect of this disclosure.

FIG. 4 is a schematic flowchart of another data processing method according to an aspect of this disclosure.

FIG. 5a is a schematic diagram of an interface for level adjustment according to an aspect of this disclosure.

FIG. 5b is a schematic diagram of an interface for another level adjustment according to an aspect of this disclosure.

FIG. 6 is a schematic flowchart of a data processing scenario according to an aspect of this disclosure.

FIG. 7a is a schematic flowchart of a palm-scanning payment scenario according to an aspect of this disclosure.

FIG. 7b is a schematic flowchart of another palm-scanning payment scenario according to an aspect of this disclosure.

FIG. 8 is a schematic structural diagram of a data processing apparatus according to an aspect of this disclosure.

FIG. 9 is a schematic structural diagram of a computer device according to an aspect of this disclosure.

### DESCRIPTION OF ASPECTS

This disclosure provides a data processing solution, which is applicable to service scenarios such as a payment scenario, an access control scenario, and a gaming scenario. Identity recognition can be performed on a user in the foregoing service scenarios, and a security credit level (i.e., a credit indicator) of the user is flexibly adjusted based on a recognition result, to change a risk control policy of the user in a corresponding service scenario, thereby meeting more service requirements in the service scenarios. Principles of the data processing solution include the following.

(1) Biological recognition data collected for the preset object is obtained when an identity recognition requirement for a preset object is detected in a service scenario (for example, when face-scanning payment is needed for the preset object in the payment scenario, or when identity verification is needed for the preset object in the access control scenario). The service scenario herein may be any service scenario of the payment scenario, an identity verification scenario (such as the access control scenario), or the gaming scenario. The preset object is any object (usually, a character object) on which identity verification or identity recognition needs to be performed. The biological recognition data herein is data that can be configured for reflecting an identity of the preset object, for example, palm data, fingerprint data, face data, and pupil data. The biological recognition data includes biometric data, for example.

(2) Identity recognition is performed on the preset object based on the biological recognition data, to obtain a recognition result of the preset object. The recognition result herein is configured for indicating whether the identity recognition on the preset object succeeds. Therefore, the recognition result includes that the recognition succeeds or the recognition fails. That the recognition succeeds means that the identity recognition on the preset object succeeds, and the recognition fails means that identity recognition on the preset object fails.

(3) A first credit indicator in the service scenario corresponding to the preset object is obtained, and level adjustment is performed on the first credit indicator based on the recognition result, to obtain a second credit indicator, a risk control policy associated with the second credit indicator being different from a risk control policy associated with the first credit indicator. The preset object is an object on which identity registration is performed in advance in the service scenario. Therefore, after the preset object performs the identity registration in the service scenario, a corresponding first credit indicator may be allocated to the preset object, and then the first credit indicator may be adjusted based on a recognition result obtained after the identity recognition is performed on the preset object in the real-time service scenario, to adjust the risk control policy of the preset object.

It can be seen from the above that in this disclosure, the identity recognition may be performed for the user (i.e., the preset object) having an identity recognition requirement in the service scenario, so that the credit indicator of the user may be flexibly adjusted based on the recognition result obtained in the identity recognition. Because different credit indicators may be associated with different risk control policies in the service scenario, as the credit indicator of the user changes (i.e., changes from the first credit indicator to the second credit indicator), the risk control policy for the user also changes. In other words, in this disclosure, a corresponding risk control policy may be flexibly adjusted based on an indicator adjustment manner in a specific service scenario, and the risk control policy of the user may be flexibly adjusted for the same user, so that a risk control management manner is more flexible.

Examples of relevant technical terms involved in the aspects of this disclosure are described below. The descriptions of the terms are provided as examples only and are not intended to limit the scope of the disclosure.

### I. Service Scenario and Preset Object:

The service scenario may include a scenario that can provide a service and support biological recognition (or identity recognition) on a preset object. The preset object herein may refer to any object in the service scenario, or a specified object in the service scenario (for example, an object needing to be paid in a payment scenario). For example, if the service is a payment service, the service scenario is the payment scenario. In the payment scenario, identity recognition is allowed to be performed on a paid object. For another example, if the service is an identity verification scenario, the service scenario is an access control scenario. In the access control scenario, identity recognition is allowed to be performed on an identity verification object. For another example, if the service is a gaming service, the service scenario may be a gaming scenario. In the gaming scenario, identity recognition may be allowed to be performed on a gaming object.

### II. Biological Recognition Data:

Biological recognition data may include data configured for performing identity recognition or biological recognition on a user (i.e., a preset object), such as biometric data. The so-called identity recognition may include at least: palm recognition, fingerprint recognition, face recognition, and pupil recognition. The biological recognition data may include, but is not limited to the palm data, the fingerprint data, the face data, and the pupil data. Specifically, the palm recognition is a technology for performing identity recognition on a user based on palm data; the fingerprint recognition is a technology for performing identity recognition on a user based on fingerprint data; the face recognition is a technology for performing identity recognition on a user based on face data; and the pupil recognition is a technology for performing identity recognition on a user based on pupil data.

This disclosure may relate to performing identity recognition on the preset object based on the palm recognition technology, to obtain a recognition result of the preset object. The recognition result may include that the recognition succeeds or the recognition fails. Specifically, the palm recognition technology may be applied to, for example, various service scenarios such as a payment scenario, an access control scenario, and a gaming scenario. For example, in a payment scenario, palm data of the preset object may be collected and identity recognition is performed on the preset object based on the palm data, and if recognition succeeds, a subsequent operation such as payment processing may be performed. For another example, in an access control scenario, palm data of the preset object may be collected, identity recognition is performed on the preset object based on the palm data, and if recognition succeeds, a subsequent operation such as opening a door may be performed.

### III. First Credit Indicator and Second Credit Indicator:

The credit indicator may be an indicator allocated to different objects in the same service scenario based on a preset management rule. For example, after identity information of a user and operation data in the service scenario are analyzed through the management rule, a credit indicator corresponding to the user may be obtained. In some aspects, the credit indicator is an indicator configured for identifying a security credit level of the user (i.e., the preset object) in the service scenario. The so-called security credit level, as the name implies, refers to a level possessed by an object in the service scenario configured to characterize security credit of the object. A data form of the security credit level may be Chinese, English, strings, and the like. Specifically, different service scenarios may have the same or different data forms of the security credit levels indicated by corresponding credit indicators in different service scenarios. In addition, the security credit levels specified in different service scenarios may have same or different types and quantities, and a specific quantity and type of the security credit levels may be different based on different management rules. For example, 4 types of security credit levels are provided in a payment scenario. For another example, 3 types of security credit levels are provided in an access control scenario. For example, a security credit level indicated by a corresponding credit indicator in the payment scenario may be expressed as a primary level, an intermediate level, a high level, or a very high level. For another example, a security credit level indicated by a corresponding credit indicator in the access control scenario may be expressed as 80%, 90%, or 100%. For still another example, a security credit level indicated by a corresponding credit indicator in a gaming scenario may be expressed as Level 1, Level 2, Level 3, and the like. In this disclosure, the first credit indicator is different from the second credit indicator. For example, the security credit level (for example, the high level) indicated by the first credit indicator may be higher than the security credit level (for example, the intermediate level) indicated by the second credit indicator. For another example, the security credit level (for example, the high level) indicated by the first credit indicator may be lower than the security credit level (for example, the very high level) indicated by the second credit indicator.

### IV. Risk Control Policy:

A full name of the “risk control policy” may include a policy for risk control. The policy for risk control is a policy configured for taking various measures and methods to eliminate or reduce various possibilities of occurrence of a risk event. Specifically, different service scenarios correspond to different risk control policies. For example, the risk control policy in a payment scenario may include a policy of risk control such as a payment amount and a payment frequency. For another example, the risk control policy in an identity verification scenario may include a policy of risk control such as identity tampering and information stealing.

In this disclosure, the risk control policy in the service scenario may be dynamically adjusted as the credit indicator of the preset object changes. Specifically, a risk control policy associated with the second credit indicator is different from a risk control policy associated with the first credit indicator. For example, in the payment scenario, if the credit indicator of the preset object is the first credit indicator (for example, a security credit level indicated by the first credit indicator may be an intermediate level), the risk control policy associated with the first credit indicator may include that a maximum payment amount of an order is 1000. When the credit indicator of the preset object is adjusted to the second credit indicator (for example, a security credit level indicated by the second credit indicator may be a high level), the risk control policy associated with the second credit indicator may include that a maximum payment amount of an order is 2000.

### V. Cloud Technology:

In this disclosure, the foregoing data processing solution may include processing procedures such as obtaining biological recognition data collected for a preset object in a service scenario, performing identity recognition on the preset object based on the biological recognition data, and performing level adjustment on the first credit indicator based on the recognition result. The processing processes usually involve a large amount of data calculation and data storage services, and require a large amount of computer operation costs. Therefore, services such as data calculation and data storage involved in this disclosure may be implemented through the cloud storage technology in the cloud technology. In other words, a blockchain is stored in the “cloud” through the cloud storage technology. When transaction data generated in a transaction process in a service system needs to be stored to the blockchain, the transaction data may be uploaded to the blockchain on the “cloud” through the cloud storage technology. In addition, when the transaction data needs to be read, the data may also be read from a blockchain on the “cloud” at any time, which can reduce a storage requirement on the computer device and expand an application range of the blockchain.

The cloud technology may include a general term for a network technology, an information technology, an integration technology, a platform management technology, and an application technology applied based on a cloud computing business model. The cloud technology may form a resource pool and be used on demand, which is flexible and convenient. A cloud computing technology becomes an important support. The cloud technology may include a cloud storage technology. The cloud storage is a new concept extended and developed based on the concept of cloud computing. A distributed cloud storage system (which is referred to as a storage system for short below) is a storage system that integrates, by using functions such as a cluster application, a grid technology, and a distributed storage file system, a large quantity of different types of storage devices in a network through application software or application interfaces to operate collaboratively, to jointly provide data storage and service access functions to the outside.

### VI. Artificial Intelligence (AI):

AI is a theory, a method, a technology, and an application system that use a digital computer or a machine controlled by the digital computer to simulate, extend, and expand human intelligence, so as to sense an environment, obtain knowledge, and obtain an optimal result with knowledge. The AI technology is a comprehensive discipline, and relates to a wide range of fields including both hardware-level technologies and software-level technologies. Basic AI technologies may include technologies such as a sensor, a dedicated AI chip, cloud computing, distributed storage, a big model training technology, an operating/interaction system, and electromechanical integration. AI software technologies mainly include several major directions such as a computer vision technology, a speech processing technology, a natural language processing technology, and machine learning (ML)/deep learning.

The data processing solution provided in the aspects of this disclosure may involve a combination of ML technologies in the field of AI. For example, a feature extraction model may be trained based on the ML technology. The trained feature extraction model (for example, a first feature extraction model and a second feature extraction model) is configured to perform feature extraction on biological recognition data of a preset object, to obtain a biological feature of the preset object. Subsequently, identity recognition may be performed on the preset object based on the biological feature of the preset object. The ML is a multi-field interdiscipline, involving a plurality of disciplines such as the probability theory, statistics, the approximation theory, convex analysis, and the algorithm complexity theory. The ML specializes in studying how a computer simulates or implements learning behaviors of humans to obtain new knowledge or skills, and reorganize a related knowledge structure, so as to keep improving performance thereof. The ML is the core of the AI and a fundamental way to make computers intelligent, which is applied in all fields of the AI. The ML and the deep learning may include technologies such as an artificial neural network, a confidence network, reinforcement learning, transfer learning, inductive learning, and learning from demonstration.

### VII. Blockchain:

A blockchain may include a new application mode of computer technologies such as distributed data storage, peer to peer (P2P) transmission, a consensus mechanism, and an encryption algorithm. The blockchain, in essence, is a decentralized database, and includes a series of data blocks (which are also referred to as blocks) generated through a cryptographic method. Each of the data blocks includes information about a batch of network transactions, which is configured for verifying effectiveness of the information (anti-counterfeiting) and generating a next data block. The blockchain ensures, in a cryptographic manner, that data cannot be tampered with and cannot be forged.

In this disclosure, the data processing procedure involves a plurality of data, for example, the biological recognition data, the recognition result, the first credit indicator, the second credit indicator, and the risk control policy. In some aspects, in this disclosure, the foregoing data may be transmitted to the blockchain for storage, and the data may be prevented from being tampered or leaked based on features such as immutable and traceable of the blockchain, thereby improving security and reliability of the data processing process.

In this disclosure, relevant data involved in the data processing procedure includes, for example, the biological recognition data, the recognition result, the first credit indicator, the second credit indicator, and the risk control policy. When the above aspects of this disclosure are applied to specific products or technologies, a user permission or consent needs to be obtained. Moreover, the processes of collection, usage, and processing of the relevant data needs to comply with laws, regulations, and standards of relevant countries and regions, and adhere to the principles of legality, legitimacy, and necessity, and do not involve data types prohibited or restricted by laws and regulations. In some examples, the relevant data involved in the aspects of this disclosure are obtained after being separately permitted by the object. In addition, when the separate permission of the object is obtained, a purpose of the relevant data is indicated to the object.

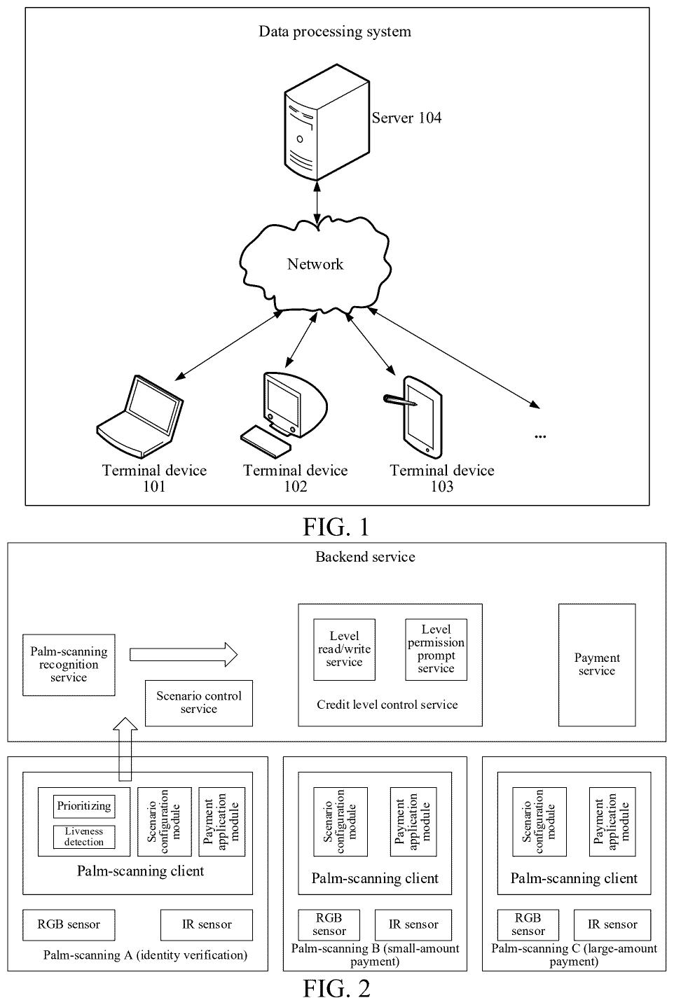

The data processing system provided in the aspects of this disclosure is described in detail below with reference to FIG. 1 and FIG. 2.

FIG. 1 is a schematic architectural diagram of a data processing system according to an aspect of this disclosure. The architecture diagram of the data processing system includes a server 104 and a terminal device cluster. The terminal device cluster includes a plurality of terminal devices such as a terminal device 101, a terminal device 102, and a terminal device 103. Any terminal device in the terminal device cluster may be directly or indirectly connected to the server 104 through wired or wireless communication.

Each terminal device in the terminal device cluster may be a mobile phone, a tablet computer, a notebook computer, a handheld computer, a mobile Internet device (MID), an on-board device, an aircraft, a wearable device (such as smart devices including a smart watch, a smart bracelet, a pedometer, and the like), a virtual reality device (for example, a virtual reality (VR) device or an augmented reality (AR) device), and the like. The types of the terminal devices in the terminal device cluster may be the same or different. For example, the terminal device 101 may be the mobile phone, and the terminal device 102 may also be the mobile phone. For another example, the terminal device 101 may be the tablet computer, and the terminal device 103 may be the on-board device. The quantity and the types of the terminal devices in the terminal device cluster are not limited in this disclosure.

The server 104 may be an independent physical server, or may be a server cluster formed by a plurality of physical servers, or a distributed system, and may further be a cloud server that provides basic cloud computing services such as cloud service, a cloud database, cloud computing, a cloud function, cloud storage, a network service, cloud communication, a middleware service, a domain name service, a security service, a content delivery network (CDN), and a big data and AI platform.

Next, using any terminal device in the data processing system (for example, the terminal device 101) as an example, an interaction process between the terminal device 101 and the server 104 is correspondingly described.

(1) The terminal device 101 obtains biological recognition data collected for a preset object in a service scenario in response to an identity recognition request of the preset object. Specifically, in a payment scenario, the identity recognition request may be a payment request submitted by the preset object; and in an access control scenario, the identity recognition request may be an identity verification request submitted by the preset object. In an example, the identity recognition request may include acquiring biological recognition data of a user collected in the service scenario.

(2) The terminal device 101 transmits the obtained biological recognition data to the server 104. After receiving the biological recognition data of the preset object, the server 104 may perform identity recognition on the preset object based on the biological recognition data, to obtain a recognition result of the preset object. In an example, the server 104 may perform identity recognition on the user based on the biological recognition data to obtain a recognition result.

(3) The server 104 may obtain a first credit indicator in the service scenario corresponding to the preset object. In an example, the server 104 may obtain a first credit indicator associated with the user in the service scenario. Server 104 may additionally perform level adjustment on the first credit indicator based on the recognition result, to obtain a second credit indicator. In an example, the server 104 adjusts the first credit indicator based on the recognition result to generate a second credit indicator.

(4) The server 104 may transmit the second credit indicator to the terminal device 101, a risk control policy associated with the second credit indicator being different from a risk control policy associated with the first credit indicator. Subsequently, the terminal device 101 may perform service management on the preset object based on the risk control policy indicated by the second credit indicator in the service scenario. In an example, the second credit indicator may be different from the first credit indicator, and a risk control policy associated with the second credit indicator may be different from the risk control policy associated with the first credit indicator.

The foregoing interaction process of data processing is merely used as an example, and does not limit specific execution processes of the terminal device and the server. For example, the obtaining a first credit indicator in the service scenario corresponding to the preset object may alternatively be performed by any terminal device. For another example, a process of analyzing and processing a diagram structure may alternatively be performed by the server. In some aspects, in the forgoing data processing procedure of this disclosure, all involved processes such as obtaining the biological recognition data, performing identity recognition on the preset object based on the biological recognition data, and performing level adjustment on the first credit indicator based on the recognition result may be independently performed by any terminal device or server.

In a possible implementation, the data processing system provided in the aspects of this disclosure may be deployed in a blockchain system. For example, the server 104 and each terminal device (such as the terminal device 101, the terminal device 102, and the terminal device 103) included in the terminal device cluster may be considered as node devices of a blockchain, and jointly form a blockchain network. Therefore, in the data processing procedure of the aspects of this disclosure, processes involved such as obtaining the biological recognition data, performing identity recognition on the preset object based on the biological recognition data, and performing level adjustment on the first credit indicator based on the recognition result may be performed the blockchain. In this way, fairness and impartiality of the data processing procedure can be ensured, the data processing procedure can be made traceable, and data security in the data processing procedure can be ensured, thereby improving security and reliability of the entire data processing procedure.

The data processing system provided in this disclosure may be applied to various service scenarios such as a payment scenario, an identity verification scenario, and a gaming scenario. Next, a specific architecture involved in a palm-scanning recognition scenario is described in detail by using an example in which the service scenario is a palm-scanning recognition scenario (such as a payment scenario and an identity verification scenario).

FIG. 2 is a schematic architectural diagram of a palm-scanning recognition scenario according to an aspect of this disclosure. As shown in FIG. 2, the palm-scanning recognition scenario involves a palm-scanning device A, a palm-scanning device B, a palm-scanning device C, and a backend server. In some aspects, the palm-scanning device A may be the terminal device 101 in the data processing system shown in FIG. 1. The palm-scanning device B may be the terminal device 102 in the data processing system shown in FIG. 1. The palm-scanning device C may be the terminal device 103 in the data processing system shown in FIG. 1. The backend server may be the server 104 in the data processing system shown in FIG. 1. The palm-scanning device A, the palm-scanning device B, and the palm-scanning device C each run a palm-scanning client (APP). Different palm-scanning devices may be applicable to the same service scenario or different service scenarios. For example, the palm-scanning device A is applicable to an identity verification scenario. For another example, the palm-scanning device B is applicable to a small-amount payment scenario (a payment amount is within 10000). For still another example, the palm-scanning device C is applicable to a large-amount payment scenario (a payment amount is within 10000). The backend server is configured to provide backend services for the foregoing palm-scanning devices (the palm-scanning device A, the palm-scanning device B, and the palm-scanning device C). Next, the palm-scanning devices (for example, the palm-scanning device A) and the backend server are respectively described in detail.

### I. Palm-Scanning Device A

The palm-scanning device A is configured with a collection device and a palm-scanning client/application (APP). The collection device may be, for example, a 3D camera (software and hardware related to detecting a living body is added to a related camera, including a depth camera and an infrared camera, to ensure information security). The 3D camera mainly includes a color sensor (RGB sensor) and an infrared sensor (IR sensor). The palm-scanning client is configured with a palm recognition module, a scenario configuration module, and a payment application module. Various modules in the palm-scanning device are described below.

(1) RGB sensor and IR sensor: They are collectively referred to as collection devices, and may be configured to collect biological streaming media data of a preset object. The RGB sensor is configured to shoot a color image. The IR sensor is configured to shoot an infrared image. The biological streaming media data of the preset object may be generated based on the color image shot by the RGB Sensor and the infrared image shot by the IR Sensor.

(2) Palm recognition module: It is configured to receive the biological streaming media data collected by the collection devices (the RGB sensor and the IR sensor) and perform data processing on the biological streaming media data to obtain biological recognition data. The data processing may include prioritizing and liveness detection. The prioritizing is performing selection on a plurality of biological images included in the biological streaming media data based on preset selection conditions (for example, conditions such as a definition, an image contrast, and an image brightness) to obtain better images. The liveness detection is distinguishing whether the preset object is a living body.

(3) Scenario configuration module: It is configured to obtain factory information of the palm-scanning device, generate scenario configuration information of the palm-scanning device A based on the factory information, and then transmit the scenario configuration information of the palm-scanning device A to the backend server for recording and storage. The scenario configuration information of the palm-scanning device A may include, but is not limited to, a device identifier (MCH_ID), a serial number (SN), a security verification level on auto_type (configured for indicating whether the palm-scanning device is self-help, namely, an unsupervised scenario) of the service scenario in which the palm-scanning device is located, and app_type (a service scenario such as payment and identity verification).

(4) Payment application module: It is configured to determine a current service scenario of the palm-scanning device based on the scenario configuration information of a current palm-scanning device and start a corresponding service. Specifically, different service scenarios may be started for different service scenarios based on the scenario configuration information. For example, if the service scenario is the payment scenario, the service started by the payment application module after recognition performed by a user through palm-scanning succeeds is: returning a payment code. For another example, if the service scenario is an access control scenario, the service started by the payment application module after recognition performed by a user through palm-scanning succeeds is: returning door opening instruction information (OPENID), or the like. In some aspects, when a user is under risk control, in other words, a current user is not authenticated to meet a security credit level of a current service scenario, prompt information is displayed. The prompt information is configured for prompting that the current user does not meet a service condition, guide the user to scan a code through a mobile phone or subsequently try again after level improvement is performed in another service scenario that can be authenticated to which a level is improved.

### II. Backend Server

The backend server is configured to provide backend services for the palm-scanning device A. Specifically, the backend services may include a palm-scanning recognition service, a scenario control service, a credit level control service, a payment service, and the like.

(1) Palm-scanning recognition service: Biological recognition data (for example, palm data) collected by a collection device in the palm-scanning device is received, and feature extraction is performed on the palm data, to perform identity recognition on the preset object. The feature extraction herein may include palm print feature extraction and palm vein feature extraction. In this way, a palm print feature and a palm vein feature of the preset object may be obtained. Subsequently, identity recognition may be performed on the preset object based on the palm print feature and the palm vein feature. Two-factor features (the palm print feature and the palm vein feature) adopted in this disclosure are richer and more accurate than a single-factor feature, which improve accuracy of identity recognition, thereby ensuring security and reliability of the data processing process.

(2) Scenario control service: It is configured for recognizing a security credit level required by each service scenario and recording a service scenario to which each palm-scanning device belongs. The service scenario may include a payment scenario, an identity verification scenario (for example, an access control scenario), and a gaming scenario. For example, the service scenario to which the palm-scanning device A belongs is the identity verification scenario, and the security credit level required by the identity verification scenario is Level 1. For another example, the service scenario to which the palm-scanning device B belongs is the small-amount payment scenario, and the security credit level required by the small-amount payment scenario is Level 2. For still another example, the service scenario to which the palm-scanning device C belongs is a large-amount payment scenario, and the security credit level required by the large-amount payment scenario is Level 3.

(3) Credit level control service: It is configured for recording a credit indicator (or a security credit level) of the current user, allocating a unique risk control policy, and providing function guidance when a security credit level indicated by the current credit indicator of the user does not meet a scenario requirement. Each credit indicator is associated with one risk control policy, and different service scenarios correspond to different risk control policies.

(4) Payment service: After identity recognition is performed on the preset object and the recognition result is obtained, if the recognition result indicates that recognition succeeds, the payment service may be invoked to complete subsequent asset transfer (for example, an asset owned by the preset object is transferred to an account of a payee object).

In the aspects of this disclosure, the identity recognition may be performed for the user (i.e., the preset object) having an identity recognition requirement in the service scenario, so that the credit indicator of the user may be flexibly adjusted based on the recognition result obtained in the identity recognition. Because different credit indicators may be associated with different risk control policies in the service scenario, as the credit indicator of the user changes (i.e., changes from the first credit indicator to the second credit indicator), the risk control policy for the user also changes. In other words, in this disclosure, a corresponding risk control policy may be flexibly adjusted based on an indicator adjustment manner in a specific service scenario, and the risk control policy of the user may be flexibly adjusted for the same user, so that a risk control management manner is more flexible.

The schematic architectural diagram of the system in the aspects of this disclosure is intended to describe the technical solutions in the aspects of this disclosure, and does not constitute a limitation on the technical solutions provided in the aspects of this disclosure. A person of ordinary skill in the art may learn that, with evolution of a system architecture and emergence of new service scenarios, the technical solutions provided in the aspects of this disclosure are also applicable to similar technical problems.

The data processing method proposed in the aspects of this disclosure is described in detail below.

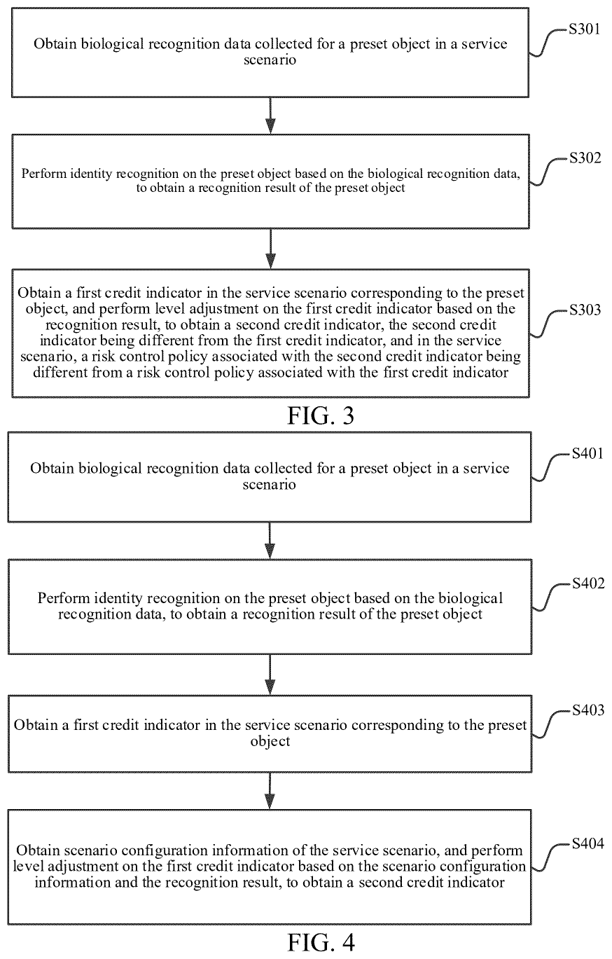

FIG. 3 is a schematic flowchart of a data processing method according to an aspect of this disclosure. The data processing method may be performed by a computer device. The computer device may be the terminal device or the server in the data processing system shown in FIG. 1. The data processing method mainly includes, but is not limited to, the following operation S301 to operation S303.

S301: Obtain biological recognition data collected for a preset object in a service scenario. In an example, biometric data of the user is acquired. The biometric data is collected in the service scenario.

In a possible implementation, the biological recognition data may be data collected in real time in a service scenario. Specifically, in response to an identity recognition request submitted by a preset object in the service scenario, the identity recognition request is configured for requesting to perform identity recognition on the preset object. Then, data collection may be performed on the preset object through an identity recognition technology (for example, a palm recognition technology, a fingerprint recognition technology, a face recognition technology, or a pupil recognition technology), to obtain the biological recognition data of the preset object. Specifically, biological recognition data collected through different types of identity recognition technologies are of different types. For example, biological recognition data obtained through the palm recognition technology is palm data. Similarly, biological recognition data obtained through the fingerprint recognition technology is fingerprint data. Biological recognition data obtained through the face recognition technology is face data, and the like. In this implementation, the biological recognition data is data collected in real time in the service scenario. The data collected in real time facilitates more accurate identity recognition on the preset object.

In another possible implementation, the biological recognition data may be historically collected data obtained from a database. Specifically, the biological recognition data of the preset object is obtained from the database, and the biological recognition data is data collected in advance in the service scenario. In this implementation, the computer device can conveniently obtain historical data collected for the preset object from the database. The historical data herein refers to data that has been collected at a historical time. The historical time point uses a current system time as a reference, and the historical time refers to time that has arrived before the current system time.

A collection process of the biological recognition data is described in detail below by using real-time data collection as an example.

In a possible implementation, that the computer device obtains the biological recognition data collected for the preset object in the service scenario may include the following operations.

(1) Invoke a collection device to collect biological streaming media data of the preset object, the biological streaming media data including a plurality of biological images collected for the preset object. The biological streaming media data may include, but is not limited to, data such as a video, an image, and audio. Specifically, the biological streaming media data of the preset object may be a plurality of biological images collected by invoking the collection device within a preset time period (for example, half a minute or one minute). Types of correspondingly obtained biological images are different in different scenarios. For example, in a palm recognition scenario, the biological image collected by invoking the collection device is a palm image. For another example, in a fingerprint recognition scenario, the biological image collected by invoking the collection device is a fingerprint image. For still another example, in a face recognition scenario, the biological image collected by invoking the collection device is a face image.

(2) Perform selection on the plurality of biological images based on a preset selection condition, to obtain the biological recognition data of the preset object. The preset selection condition herein includes any one or more of an image size (for example, a size such as a length or a width of an image), a capture angle (for example, 90 degrees or 45 degrees), an image contrast, an image brightness, and a definition. In some aspects, if a plurality of biological images are selected based on the preset selection condition, selection may be performed again on the plurality of biological images. The re-selection herein may include a selection manner such as random selection or selection based on a collection time. For example, if three biological images are selected based on the preset selection condition: img1, img2, and img3, and the collection times of the three biological images are sequentially: img1>img2>img3, img1 may be used as final biological recognition data. In some aspects, after the biological image is selected based on the preset selection condition, image processing (for example, image enhancement) may be further performed on the selected biological image, and the biological image after the image processing is used as the biological recognition data of the preset object.

According to the foregoing manner, biological recognition data configured for identity recognition is obtained after prioritizing is performed on the collected biological streaming media data, so that the biological recognition data can be more accurate and reliable.

S302: Perform identity recognition on the preset object based on the biological recognition data, to obtain a recognition result of the preset object. In an example, identity recognition is performed on the user based on the biometric data to obtain a recognition result.

Specifically, the essence of performing identity recognition on the preset object is to recognize the identity of the preset object. The biological feature is a feature that can uniquely identify a user identity. Therefore, in this disclosure, the performing identity recognition on the preset object based on the biological recognition data of the preset object specifically includes the following. The type of the biological recognition data may be obtained, and identity recognition is performed through a matching identity recognition technology based on different types of biological recognition data (where one type of biological recognition data matches one identity recognition technology), so as to perform recognition and authentication on the user identity. For example, if the biological recognition data is the palm data, palm recognition may be performed on the palm data through the palm recognition technology. For another example, if the biological recognition data is the fingerprint data, fingerprint recognition may be performed on the fingerprint data through the fingerprint recognition technology. For still another example, if the biological recognition data is face data, face recognition may be performed on the face data through the face recognition technology.

A specific process for performing identity recognition on the preset object is described in detail below.

In a possible implementation, that the computer device performs identity recognition on the preset object based on the biological recognition data, to obtain a recognition result of the preset object may include the following operations. (1) Perform feature extraction on the biological recognition data, to obtain a biological feature of the preset object. For example, if the biological recognition data is the palm data, the biological feature obtained by the feature extraction may be a palm feature. For another example, if the biological recognition data is the fingerprint data, the biological feature obtained by the feature extraction may be the fingerprint feature. For still another example, if the biological recognition data is the face data, the biological features obtained through feature extraction may be the face feature. (2) Obtain registration data of the preset object, the registration data being generated after the preset object successfully performs identity registration in the service scenario, and the registration data including a registration feature. If the preset object performs the identity registration based on palm registration, the registration feature of the preset object includes the palm feature. Similarly, if the preset object performs identity registration based on face registration, the registration feature of the preset object includes the face feature. (3) Perform the identity recognition on the preset object based on the biological feature of the preset object and the registration feature of the preset object, to obtain the recognition result of the preset object, the recognition result including that the recognition succeeds or the recognition fails. Specifically, feature matching may be performed on the biological feature and the registration feature, to perform identity recognition on the preset object. Specifically, a feature similarity between the biological feature and the registration feature of the preset object may be calculated. If the feature similarity is greater than or equal to a similarity threshold, it may be determined that the identity recognition on the preset object succeeds. In other words, it is determined that the recognition result indicates that the recognition succeeds. If the feature similarity is less than the similarity threshold, it may be determined that the identity recognition on the preset object fails. In other words, it is determined that the recognition result indicates that the recognition fails.

Next, a specific process of performing the feature extraction on the palm data is described in detail by using an example in which the biological recognition data is the palm data. In a possible implementation, that the computer device performs feature extraction on the biological recognition data, to obtain the biological feature of the preset object may include the following operations.

(1) Perform palm vein feature extraction on the palm data, to obtain a palm vein feature of the preset object; and perform palm print feature extraction on the palm data, to obtain a palm print feature of the preset object. Specifically, the palm print feature of the preset object may be extracted through a first feature extraction model, and the palm vein feature of the preset object may be extracted through a second feature extraction model. The first feature extraction model may be the same as or may not be the same as the second feature extraction model. For example, the first feature extraction model or the second feature extraction model may be a neural network model. For example, the neural network model may include, but is not limited to a convolutional neural network (CNN) model, a recurrent neural network (RNN) model, a long short term memory (LSTM) model, a gated recurrent unit (GRU) model, and the like. A model structure of the neural network model is not specifically limited in this aspect of this disclosure.

(2) Perform feature fusion on the palm print feature and the palm vein feature, to obtain the biological feature of the preset object, the feature fusion including at least any one of feature weighting, feature alignment, or feature calculation. For example, weighting calculation may be performed on the palm print feature and the palm vein feature, to obtain the biological feature of the preset object. For another example, average calculation may be performed on the palm print feature and the palm vein feature, to obtain the biological feature of the preset object. For still another example, feature alignment (for example, if a feature dimension of the palm print feature is k1×k2 and a feature dimension of the palm vein feature is k2×k3, the feature dimension of the palm vein feature may be aligned with the feature dimension of the palm print feature. Because the feature dimensions of two features are the same after the feature alignment, subsequent feature processing may be facilitated) may be performed on the palm print feature and the palm vein feature, to obtain the biological feature of the preset object.

According to the foregoing manner, when the biological recognition data of the preset object is the palm data, a two-factor feature of the palm print and the palm vein (the palm vein feature and the palm print feature) of the preset object may be extracted for identity recognition. An advantage of the two-factor feature compared with a single-factor feature (the palm vein feature or the palm print feature) lies in higher accuracy and security during identity recognition. In addition, recognition of the palm vein feature is difficult, and is not easy to be forged or simulated. Therefore, a manner of extracting the two-factor feature can improve accuracy and reliability of identity recognition of the preset object.

S303: Obtain a first credit indicator in the service scenario corresponding to the preset object, and perform level adjustment on the first credit indicator based on the recognition result, to obtain a second credit indicator, in the service scenario, a risk control policy associated with the second credit indicator being different from a risk control policy associated with the first credit indicator. In an example, a first permission level associated with the user in the service scenario is obtained. The first permission level is adjusted based on the recognition result to generate a second permission level. The second permission level is different from the first permission level. A second permission limit associated with the second permission level is different from a first permission limit associated with the first permission level.

Specifically, in the service scenario, the risk control policy for the same user may be dynamically adjusted based on level adjustment of the credit indicators. In other words, for the preset object, the risk control policy associated with the second credit indicator is different from the risk control policy associated with the first credit indicator. For example, if the service scenario is the payment scenario, the risk control policy associated with the security credit level (for example, an intermediate level) indicated by the first credit indicator of the preset object in the payment scenario may be a policy used when the maximum payment amount of any order paid by the preset object is greater than 1000. The risk control policy associated with the security credit level (for example, a high level) indicated by the first credit indicator of the preset object may be a policy used when the maximum payment amount of any order paid by the preset object is greater than 2000. In other words, in the payment scenario, the risk control policy is configured for controlling the maximum payment amount of a single order paid by the user.

In a possible implementation, that the computer device performs the level adjustment on the first credit indicator based on the recognition result, to obtain the second credit indicator may include: performing level improvement on the first credit indicator in a first adjustment manner if the recognition result indicates that the recognition succeeds, to obtain the second credit indicator. The first adjustment manner is configured for instructing to perform the level improvement on the security credit level indicated by the first credit indicator. If the security credit level is Level 1, the preset object may be adjusted from Level 1 to Level 2 based on the first adjustment manner, to obtain the second credit indicator of the preset object.

In another possible implementation, that the computer device performs the level adjustment on the first credit indicator based on the recognition result, to obtain the second credit indicator may further include: obtaining scenario configuration information of the service scenario, the scenario configuration information including a security verification level of the service scenario; and performing level improvement on the first credit indicator in a first adjustment manner if the security verification level of the service scenario meets a level adjustment condition and the recognition result indicates that the recognition succeeds, to obtain the second credit indicator. The security verification level is configured for indicating whether object supervision exists in the service scenario. If the service scenario is a scenario with object supervision, the security verification level of the service scenario is the first level; and if the service scenario is a scenario without object supervision, the security verification level of the service scenario is the second level.

A specific process of the level adjustment of the first credit indicator is described in detail below.

### I: The Level Adjustment is Performed on the First Credit Indicator Based on the Recognition Result.

In a possible implementation, that the computer device performs the level adjustment on the first credit indicator based on the recognition result may include the following several manners. (1) Level improvement is performed on the first credit indicator in a first adjustment manner if the recognition result indicates that the recognition succeeds, to obtain the second credit indicator. For example, the preset object from Level 2 (the first credit indicator) is improved to Level 3 (the second credit indicator). (2) Level lowering is performed on the first credit indicator in a second adjustment manner if the recognition result indicates that the recognition fails, to obtain a third credit indicator. For example, the preset object is lowered from Level 2 (the first credit indicator) to Level 1 (the third credit indicator). (3) Level keeping is performed on the first credit indicator if the recognition result indicates that the recognition fails, in other words, Level 2 (the first credit indicator) of the preset object is kept. The first adjustment manner is different from the second adjustment manner. The differences herein may include the following. A level adjustment amplitude for the first credit indicator is different (i.e., a level adjustment amplitude indicated by the first adjustment manner is different from a level adjustment amplitude indicated by the second adjustment manner), and a level adjustment manner for the first credit indicator is different.

Specifically, if the security credit level indicated by the first credit indicator an intermediate level, the adjustment amplitude indicated by the first adjustment manner may be improved by one level, and the credit indicator of the preset object may be improved from the intermediate level to the high level. If the security credit level indicated by the first credit indicator is an intermediate level, the adjustment amplitude indicated by the second adjustment manner may be lowering by one level, and the credit indicator of the preset object may be lowered from the intermediate level to the primary level. The adjustment amplitude of the first adjustment manner may be the same as or may be different from the adjustment amplitude of the second adjustment manner. For example, the level adjustment may include the following. When the level is improved, the level may be increased by one level. When the level is lowered, the level may also be decreased by one level. For another example, the level adjustment may further include the following. When the level is improved, the level may be increased by two levels. When the level is lowered, the level may also be decreased by two levels. In this implementation, adjustment may be performed on the credit indicator based on the recognition result. If the recognition succeeds, the security credit level of the credit indicator of the preset object is increased, and if the recognition fails, the security credit level of the credit indicator of the preset object is decreased.

### II. The Level Adjustment is Performed on the First Credit Indicator Based on the Service Scenario and the Recognition Result Comprehensively.

In a possible implementation, that the computer device performs the level adjustment on the first credit indicator based on the recognition result and the scenario configuration information of the service scenario may include the following several manners.

(1) Level improvement is performed on the first credit indicator in a first adjustment manner if the security verification level of the service scenario meets a level adjustment condition and the recognition result indicates that the recognition succeeds, to obtain the second credit indicator. For example, if the service scenario is a scenario (i.e., the security verification level of the service scenario is the first level) in which the object supervision exists and the recognition result is that recognition succeeds, the preset object may be improved from Level 2 (the first credit indicator) to Level 3 (the second credit indicator).

(2) Level lowering is performed on the first credit indicator in a second adjustment manner if the security verification level of the service scenario does not meet the level adjustment condition or the recognition result indicates that the recognition fails, to obtain a third credit indicator. For example, if the service scenario is a scenario (i.e., the security verification level of the service scenario is the second level) in which the object supervision does not exist, or the recognition result indicates that the recognition fails, the preset object may be lowered from Level 2 (the first credit indicator) to Level 1 (the third credit indicator).

(3) Level keeping is performed on the first credit indicator if the security verification level of the service scenario meets the level adjustment condition or the recognition result indicates that the recognition fails. For example, if the service scenario is a scenario (i.e., the security verification level of the service scenario is the first level) in which the object supervision exists and the recognition result is that recognition succeeds, Level 2 (the first credit indicator) of the preset object may be kept.

(4) Level keeping is performed on the first credit indicator if the security verification level of the service scenario does not meet the level adjustment condition and the recognition result indicates that the recognition succeeds. For example, if the service scenario is a scenario (i.e., the security verification level of the service scenario is the second level) in which the object supervision does not exist and the recognition result is that recognition succeeds, Level 2 (the first credit indicator) of the preset object may be kept.

In the above manners (1)-(4), the level adjustment condition may include a condition in which the object supervision exists. For example, if the security verification level of the service scenario is the first level, the service scenario meets the level adjustment condition. For another example, if the security verification level of the service scenario is the second level, the service scenario does not meet the level adjustment condition. In other words, the level adjustment condition is configured for indicating that the level adjustment can only be performed in a scenario in which the object supervision exists.

### III. The Level Adjustment is Performed on the First Credit Indicator Based on the Service Scenario, the Historical Service Data, and the Recognition Result Comprehensively.

In a possible implementation, if the security verification level of the service scenario does not meet the level adjustment condition (i.e., the service scenario is a scenario in which the object supervision does not exist), the historical service data of the preset object may be obtained, and the level adjustment is performed on the first credit indicator of the preset object based on the obtained historical service data and the recognition result. The historical service data may at least include: service data generated by the preset object in a service scenario in a historical time period, and data generated by the preset object in another service scenario (for example, a scenario in which the object supervision exists) in a historical time period. For example, in the payment scenario, the historical service data may include historical payment data generated by the preset object in a historical month (i.e., one month backward from a current time point). The computer device may use the obtained historical payment data of the preset object as sample data, and train a level recognition model based on the sample data. The level recognition model may be configured to recognize the security credit level of the preset object in the service scenario. The level recognition model herein may be a neural network model of any network structure, which is not limited in the aspect of this disclosure. Subsequently, level recognition may be performed on the preset object based on the trained level recognition model. The level recognition herein refers to recognizing the security credit level of the preset object. (1) For example, if the identified security credit level meets a credit level threshold (for example, a high level) and the recognition result indicates that the recognition succeeds, level improvement may be performed on the preset object. In other words, the preset object is improved from the first credit indicator to the second credit indicator. (2) For another example, if the recognized security credit level meets a credit level threshold (for example, a high level) or the recognition result indicates that the recognition fails, level keeping may be performed on the preset object. (3) For still another example, if the identified security credit level does not meet the credit level threshold and the recognition result indicates that the recognition fails, level lowering may be performed on the preset object. In other words, the preset object is decreased from the first credit indicator to the third credit indicator.

Specifically, the historical payment data may include data such as a payment time, a payment quantity, and a payment amount. When the computer device trains the level recognition model based on the historical payment data, the following may be specifically included. First, data analysis may be performed on the historical payment data of the preset object, to extract payment features (features such as whether payment is performed on time, whether a payment frequency is frequent, and whether a payment amount is abnormal). Then, the level recognition model is trained based on the extracted payment feature. In this manner, the level recognition model may be trained based on the historical payment data of the user, so that the trained level recognition model may be configured to evaluate the security credit level of the user, to meet a special service requirement that the level adjustment may be performed based on personal historical service data when the service scenario is in an unsupervised condition for a long time. Because the level recognition model is obtained by performing training based on the historical service data of the user, the security credit level obtained by recognizing the user through the level recognition model is highly reliable, so that the level adjustment may be accurately and reliably performed on the credit indicator of the user.

In the aspects of this disclosure, the identity recognition may be performed for the user (i.e., the preset object) having an identity recognition requirement in the service scenario, so that the credit indicator of the user may be flexibly adjusted based on the recognition result obtained in the identity recognition. Because different credit indicators may be associated with different risk control policies in the service scenario, as the credit indicator of the user changes (i.e., changes from the first credit indicator to the second credit indicator), the risk control policy for the user also changes. In other words, in this disclosure, a corresponding risk control policy may be flexibly adjusted based on an indicator adjustment manner in a specific service scenario, and the risk control policy of the user may be flexibly adjusted for the same user, so that a risk control management manner is more flexible.

FIG. 4 is a schematic flowchart of another data processing method according to an aspect of this disclosure. The data processing method may be performed by a computer device. The computer device may be the terminal device or the server in the data processing system shown in FIG. 1. The data processing method mainly includes, but is not limited to, the following operation S401 to operation S404.

S401: Obtain biological recognition data collected for a preset object in a service scenario.

In a possible implementation, that the computer device obtains the biological recognition data collected for the preset object in the service scenario may include the following operations. (1) Invoke a collection device to collect biological streaming media data of the preset object, the biological streaming media data including a plurality of biological images collected for the preset object. The biological streaming media data may include, but is not limited to, data such as a video, an image, and audio. Specifically, the biological streaming media data of the preset object may be a plurality of biological images collected by invoking the collection device within a preset time period (for example, half a minute or one minute). Types of correspondingly obtained biological images are different in different scenarios. For example, in a palm recognition scenario, the biological image collected by invoking the collection device is a palm image. For another example, in a fingerprint recognition scenario, the biological image collected by invoking the collection device is a fingerprint image. For still another example, in a face recognition scenario, the biological image collected by invoking the collection device is a face image. (2) Perform selection on the plurality of biological images based on a preset selection condition, to obtain the biological recognition data of the preset object. The preset selection condition herein includes any one or more of an image size (for example, a size such as a length or a width of an image), a capture angle (for example, 90 degrees or 45 degrees), an image contrast, an image brightness, and a definition. In some aspects, if a plurality of biological images are selected based on the preset selection condition, selection may be performed again on the plurality of biological images. The selection herein may include manners such as random selection, selection based on collection time. For example, if three biological images are selected based on the preset selection condition: img1, img2, and img3, and the collection times of the three biological images are sequentially: img1>img2>img3, img1 may be used as final biological recognition data. In some aspects, after the biological image is selected based on the preset selection condition, image processing (for example, image enhancement) may be further performed on the selected biological image, and the biological image after the image processing is used as the biological recognition data of the preset object.

According to the foregoing manner, biological recognition data configured for identity recognition is obtained after prioritizing is performed on the collected biological streaming media data, so that the biological recognition data can be more accurate and reliable.

S402: Perform identity recognition on the preset object based on the biological recognition data, to obtain a recognition result of the preset object.

Specifically, the essence of performing identity recognition on the preset object is to recognize the identity of the preset object. The biological feature is a feature that can uniquely identify a user identity. Therefore, in this disclosure, identity recognition may be performed on the preset object based on the biological recognition data of the preset object. Specifically, recognition may be performed through a corresponding technology based on different types of biological recognition data, so as to perform recognition and authentication on a user identity. For example, if the biological recognition data is the palm data, palm recognition may be performed on the palm data through the palm recognition technology. For another example, if the biological recognition data is the fingerprint data, fingerprint recognition may be performed on the fingerprint data through the fingerprint recognition technology. For still another example, if the biological recognition data is face data, face recognition may be performed on the face data through the face recognition technology.

For details of execution operations corresponding to operation S401 to operation S402 in this aspect of this disclosure, reference may be made to execution operations corresponding to operation S301 to operation S302 in the aspect of FIG. 3. Details are not described herein again in this aspect of this disclosure.

In a possible implementation, after the computer device performs identity recognition on the preset object based on the biological recognition data, to obtain a recognition result of the preset object, the method further includes the following operations: outputting a prompt interface if the recognition result indicates that the recognition succeeds, the prompt interface including a prompt area and an adjustment control, the prompt area being configured to prompt the preset object to permit or not permit the level adjustment on the first credit indicator, and the adjustment control being configured to receive a confirmation operation for the level adjustment on the first credit indicator; and triggering, in response to a permission confirmation operation triggered by the preset object in the prompt area, the operation of obtaining the first credit indicator in the service scenario corresponding to the preset object, and performing the level adjustment on the first credit indicator based on the recognition result. Specifically, the first credit indicator is adjusted to the second credit indicator in response to a permission confirmation operation triggered for the first control in the prompt area when the recognition result indicates that the recognition succeeds; the first credit indicator is lowered to the third credit indicator in response to a permission confirmation operation triggered for the second control in the prompt area when the recognition result indicates that the recognition fails; and the level keeping is performed on the first credit indicator in response to a permission confirmation operation triggered for the third control in the prompt area when the recognition result indicates that the recognition succeeds or fails.

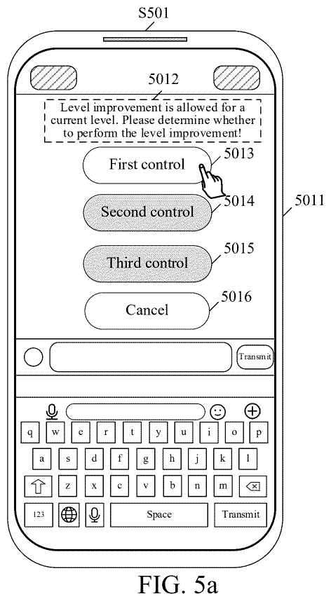

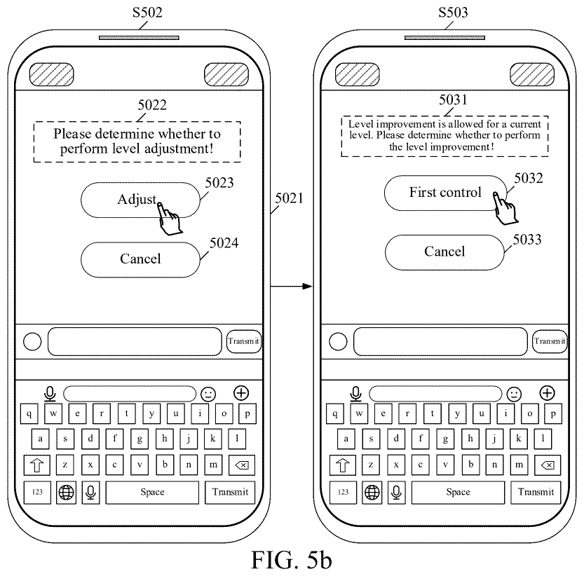

An interface procedure of how to perform level adjustment is correspondingly described below with reference to FIG. 5a and FIG. 5b.

FIG. 5a is a schematic diagram of an interface for level adjustment according to an aspect of this disclosure. As shown in FIG. 5a, the prompt interface S501 is provided with a prompt area 5011, prompt information is displayed in the prompt area 5011, and the prompt information is configured for prompting whether a preset object permits level adjustment on a first credit indicator. The level adjustment includes any one or more of level lowering, level improvement, and level keeping. For example, the prompt information 5012 may be: level improvement is allowed for a current level. Please determine whether to perform the level improvement. An adjustment control is further arranged in the prompt interface S501. The adjustment control is configured to receive a confirmation operation for level adjustment of the first credit indicator. The adjustment controls include a first control 5013, a second control 5014, and a third control 5015. In addition, the prompt interface S501 is also provided with a cancel control 5016. The first control 5013 is configured to receive a confirmation operation for the level improvement; the second control 5014 is configured to receive a confirmation operation for the level lowering; the third control 5015 is configured to receive a confirmation operation for the level keeping; and the cancel control 5016 is configured to receive a cancellation operation for the level adjustment. For example, if the prompt information indicates that level improvement is performed on the first credit indicator, the user may click/tap the first control 5013 to improve the level of the first credit indicator to the second credit indicator. In this case, because the level adjustment is the level improvement, a state of the second control 5014 and a state of the third control 5015 may both be set to a non-clicking/non-tapping state. In other words, both the second control 5014 and the third control 5015 cannot respond to a click/tap operation (such as any one of a click operation, a double click operation, or a press and hold operation) of the user. In this case, the user is allowed to click/tap the first control 5013 and the cancel control 5016, but the user is not allowed to click the second control 5014 and the third control 5015. Similarly, if the prompt information indicates that the level lowering is performed on the first credit indicator, in this case, the user is allowed to click/tap the second control 5014 and the cancel control 5016, but is not allowed to click/tap the first control 5013 and the third control 5015.

FIG. 5b is a schematic diagram of an interface for another level adjustment according to an aspect of this disclosure. As shown in FIG. 5b, the prompt interface S502 is provided with a prompt area 5021, prompt information is displayed in the prompt area 5021, and the prompt information is configured for prompting whether a preset object permits level adjustment on a first credit indicator. The level adjustment includes any one or more of level lowering, level improvement, and level keeping. For example, the prompt information 5022 may be that please determine whether to perform level adjustment. The prompt interface S502 is further provided with an adjustment control 5023 and a cancel control 5024. If the user clicks/taps the cancel control 5024, it indicates that the user does not agree to perform level adjustment. If the user clicks/taps the adjustment control 5023, a prompt interface S503 may be displayed. Prompt information 5031 is displayed on the prompt interface S503. For example, the prompt information 5031 may be: level improvement is allowed for a current level. Please determine whether to perform the level improvement. In this case, a first control 5032 and a cancel control 5033 are displayed on the prompt interface S503. If the user clicks/taps the first control 5032, the user agrees to perform level adjustment, and the first credit indicator may be improved to the second credit indicator.

Based on the above description, after identity recognition is performed on the user (the preset object), a prompt interface may be outputted, so that the user self-defines whether to perform the level adjustment. This manner can meet a special service requirement that the user does not want to perform level adjustment, thereby improving user experience in a service scenario.

S403: Obtain a first credit indicator in the service scenario corresponding to the preset object.

In a possible implementation, the first credit indicator is a credit indicator allocated to the preset object after the preset object completes the identity registration in the service scenario. If the service scenario is a payment scenario, before the computer device obtains biological recognition data collected for a preset object in a service scenario, the method further includes: obtaining scenario configuration information of the payment scenario in response to an identity registration request of the preset object in the payment scenario, the scenario configuration information including a security verification level of the payment scenario; allocating the credit indicator to the preset object in the payment scenario based on the security verification level of the payment scenario if the security verification level of the payment scenario meets the level adjustment condition; and determining a reference credit indicator as the credit indicator allocated to the preset object in the payment scenario if the security verification level of the payment scenario does not meet the level adjustment condition.

Specifically, if the payment scenario is a scenario (i.e., the security verification level of the payment scenario is a first level, for example, the first level is a high level) in which object supervision exists, the security verification level (the high level) of the payment scenario may be used as the first credit indicator (the high level) of the preset object. If the payment scenario is a scenario (i.e., the security verification level of the payment scenario is the second level) in which object supervision does not exist, it may be default that the first credit indicator of the user is the primary level (the reference credit indicator). In this manner, a corresponding credit indicator may be allocated to the preset object based on the security verification level (i.e., whether the object supervision exists) of the service scenario during the identity registration, so that the credit indicator of the preset object meets scenario requirements better.

S404: Obtain scenario configuration information of the service scenario, and perform level adjustment on the first credit indicator based on the scenario configuration information and the recognition result, to obtain a second credit indicator.

In a possible implementation, that the computer device performs the level adjustment on the first credit indicator based on the scenario configuration information and the recognition result, to obtain the second credit indicator may include: performing level improvement on the first credit indicator in a first adjustment manner if the security verification level of the service scenario meets a level adjustment condition and the recognition result indicates that the recognition succeeds, to obtain the second credit indicator. The security verification level is configured for indicating whether object supervision exists in the service scenario. If the service scenario is a scenario with object supervision, the security verification level of the service scenario is the first level; and if the service scenario is a scenario without object supervision, the security verification level of the service scenario is the second level. The level adjustment condition may include a condition in which the object supervision exists. For example, if the security verification level of the service scenario is the first level, the service scenario meets the level adjustment condition. For another example, if the security verification level of the service scenario is the second level, the service scenario does not meet the level adjustment condition. For example, if the service scenario is a scenario (i.e., the security verification level of the service scenario is the first level) in which the object supervision exists and the recognition result is that recognition succeeds, the preset object may be improved from Level 2 (the first credit indicator) to Level 3 (the second credit indicator).

The aspects of this disclosure provide a data processing method, which is applicable to service scenarios such as a payment scenario, an access control scenario, and a gaming scenario. Identity recognition can be performed on a user in the foregoing service scenarios, and a security credit level (i.e., a credit indicator) of the user is flexibly adjusted based on a recognition result, to change a risk control policy of the user in a corresponding service scenario, thereby meeting more service requirements in the service scenarios.

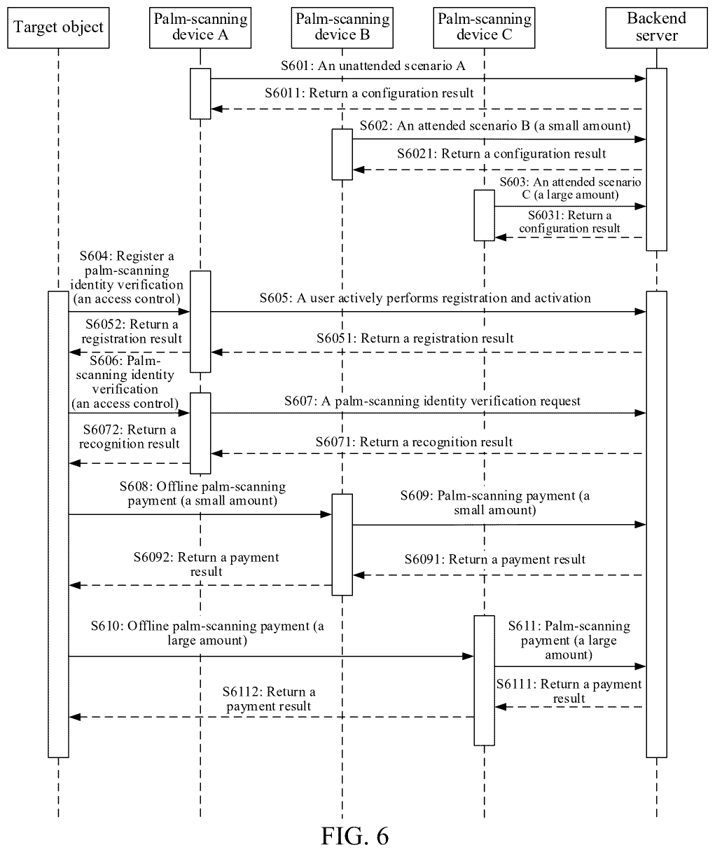

An example of a process of the data processing scenario is described in detail below with reference to FIG. 6.

FIG. 6 is a schematic flowchart of a data processing scenario according to an aspect of this disclosure. As shown in FIG. 6, a procedure of the data processing scenario mainly involves: the palm-scanning device A, the palm-scanning device B, the palm-scanning device C, and the backend server in the data processing system shown in FIG. 2. The procedure of the data processing scenario mainly includes, but is not limited to, the following operation S601 to operation S611. Specifically, the procedure of the data processing scenario mainly involves: a scenario configuration procedure, an identity registration procedure, and a palm-scanning recognition procedure. Specific operations of the foregoing three procedures re correspondingly described sequentially below.

### I. Scenario Configuration Procedure (S601-S603).

S601: The palm-scanning device A submits a first scenario configuration request of an unattended scenario A to the backend server.

During specific implementation, a service scenario A to which the palm-scanning device A belongs is a scenario (i.e., the unattended scenario A) in which object supervision does not exist. The service scenario A is an identity verification scenario. The palm-scanning device A may generate a first scenario configuration request for a preset object in the service scenario A, and transmit the first scenario configuration request to the backend server. The first scenario configuration request includes scenario configuration information of the service scenario A. For example, the scenario configuration information may include, but is not limited to, a security verification level (configured for indicating whether the object supervision exists/whether attendance exists) of the service scenario A.

In some aspects, the backend server may perform scenario configuration for a service scenario B in response to the first scenario configuration request and based on the scenario configuration information of the service scenario A, to obtain a configuration result. The configuration result may include: the configuration succeeds or the configuration fails. Subsequently, the backend server may return the configuration result to the palm-scanning device A (as shown in operation S6011).

S602: A palm-scanning device B submits a second scenario configuration request of an attended scenario B to the backend server.

During specific implementation, the service scenario B to which the palm-scanning device B belongs is a scenario (i.e., the attended scenario B) in which the object supervision does not exist. The service scenario is a small-amount payment scenario (i.e., a payment amount is less than a first payment threshold). The palm-scanning device B may generate the second scenario configuration request for the preset object in the service scenario B and transmit the second scenario configuration request to the backend server. The second scenario configuration request includes scenario configuration information of the service scenario B. For example, the scenario configuration information may include, but is not limited to, B security verification level (configured for indicating whether the object supervision exists/whether attendance exists) of the service scenario B.

In some aspects, the backend server may perform scenario configuration for a service scenario B in response to the second scenario configuration request and based on the scenario configuration information of the service scenario B, to obtain a configuration result. The configuration result may include: the configuration succeeds or the configuration fails. Subsequently, the backend server may return the configuration result to the palm-scanning device B (as shown in operation S6021).

S603: The palm-scanning device C submits a third scenario configuration request of an attended scenario C to the backend server.

During specific implementation, the service scenario C to which the palm-scanning device C belongs is a scenario (i.e., the attended scenario C) in which the object supervision does not exist. The service scenario C is a large-amount payment scenario (i.e., a payment amount is greater than or equal to a second payment threshold, and the second payment threshold is greater than the first payment threshold). The palm-scanning device C may generate the third scenario configuration request for the preset object in the service scenario C, and transmit the third scenario configuration request to the backend server. The third scenario configuration request includes scenario configuration information of the service scenario C. For example, the scenario configuration information may include, but is not limited to, security verification level (configured for indicating whether the object supervision exists/whether attendance exists) of the service scenario C.

In some aspects, the backend server may perform scenario configuration for a service scenario C in response to the third scenario configuration request and based on the scenario configuration information of the service scenario C, to obtain a configuration result. The configuration result may include: the configuration succeeds or the configuration fails. Subsequently, the backend server may return the configuration result to the palm-scanning device C (as shown in operation S6031).

### II. An Identity Registration Procedure and a Palm-Scanning Recognition Procedure (S604-S611).

S604: The palm-scanning device A obtains an identity registration request of palm-scanning identity verification of a preset object.

During specific implementation, the preset object may perform identity registration in the service scenario A (i.e., an access control scenario of the palm-scanning identity verification) to which the palm-scanning device A belongs, to generate an identity registration request. The identity registration request may include identity information of the preset object. For example, the identity information may include, but is not limited to, data configured for uniquely identifying a user identity, such as an identity and an ID. In this disclosure, because the palm-scanning recognition is mainly involved, the identity information of the preset object may include palm data of the preset object.

S605: The palm-scanning device A performs identity registration with the backend server based on the identity registration request.

During specific implementation, after receiving the identity registration request, the backend server may perform identity registration on the preset object based on the identity information of the preset object, and allocate a credit indicator (for example, a first credit indicator) to the preset object in the service scenario A after the identity registration is completed, to generate a registration result. The registration result may include: the registration succeeds or the registration fails.

In some aspects, the backend server may return the registration result to the palm-scanning device A (as shown in operation S6051). In addition, the palm-scanning device A may return the registration result to the preset object (as shown in operation S6052).

S606: The palm-scanning device A obtains a palm-scanning identity verification request of the preset object.

During specific implementation, the preset object needs to request door opening in the service scenario A (i.e., the access control scenario of the palm-scanning identity verification), and the palm-scanning identity verification request may be submitted to the palm-scanning device A. The palm-scanning identity verification request is configured for requesting to perform identity recognition (for example, palm recognition) on the preset object.

S607: The palm-scanning device A transmits the palm-scanning identity verification request to the backend server.

During specific implementation, in response to the palm-scanning identity verification request, the palm-scanning device A invokes, in the service scenario A, a collection device to collect biological recognition data of the preset object, and transmits the collected biological recognition data to the backend server.

In some aspects, the backend server performs identity recognition on the preset object based on the biological recognition data, to obtain a recognition result (recognition succeeds or recognition fails) of the preset object, and returns the recognition result to the palm-scanning device A (as shown in operation S6071). Subsequently, the palm-scanning device may return the recognition result to the preset object (as shown in operation S6072).

S608: The palm-scanning device B obtains a palm-scanning payment request (a small amount) of the preset object.

During specific implementation, the palm-scanning payment request is configured for requesting processing of a small-amount asset. The small-amount asset means that an asset amount is less than a first payment threshold.

S609: The palm-scanning device B requests the backend server to perform a palm-scanning payment (a small amount).

During specific implementation, the backend server responds to the small-amount palm-scanning payment request of the preset object, and performs palm-scanning recognition on the preset object. If the palm-scanning recognition performed on the preset object is succeeds, a payment service may be invoked to perform asset transfer (payment), so as to generate a payment result. The payment result may include the payment succeeds or the payment fails.

In some aspects, the backend service may return the payment result to the palm-scanning device B (as shown in operation S6091), and the palm-scanning device B may return the payment result to the preset object (as shown in operation S6092).

S610: The palm-scanning device C obtains a palm-scanning payment request (a large amount) of the preset object.

During specific implementation, the palm-scanning payment request is configured for requesting processing of a large-amount asset. The large-amount asset means that an asset amount is greater than or equal to a second payment threshold, and the second payment threshold is greater than the first payment threshold.

S611: The palm-scanning device C requests the backend server to perform a palm-scanning payment (a large amount).

During specific implementation, the backend server responds to the large-amount palm-scanning payment request of the preset object, and performs palm-scanning recognition on the preset object. If the palm-scanning recognition performed on the preset object is succeeds, a payment service may be invoked to perform asset transfer (payment), so as to generate a payment result. The payment result may include the payment succeeds or a payment fails.

In some aspects, the backend service may return the payment result to the palm-scanning device C (as shown in operation S6111), and the palm-scanning device C may return the payment result to the preset object (as shown in operation S6112).

The palm-scanning recognition process is described in detail below by using the payment scenario as an example.

In a possible implementation, the service scenario is a payment scenario, a risk control policy in the payment scenario being configured for indicating that one credit indicator corresponds to one payment amount. After a computer device performs the level adjustment on the first credit indicator based on the recognition result, to obtain a second credit indicator, the method further includes the following operations: detecting an asset amount requested to be processed in the payment scenario; invoking, if the payment amount corresponding to the second credit indicator is greater than or equal to the asset amount requested to be processed, a payment service to perform transfer on an asset corresponding to the asset amount; and outputting prompt information if the payment amount corresponding to the second credit indicator is less than the asset amount requested to be processed, the prompt information being configured for triggering the level adjustment on the second credit indicator of the preset object, to cause a payment amount corresponding to the second credit indicator after the level adjustment to be greater than or equal to the asset amount requested to be processed.

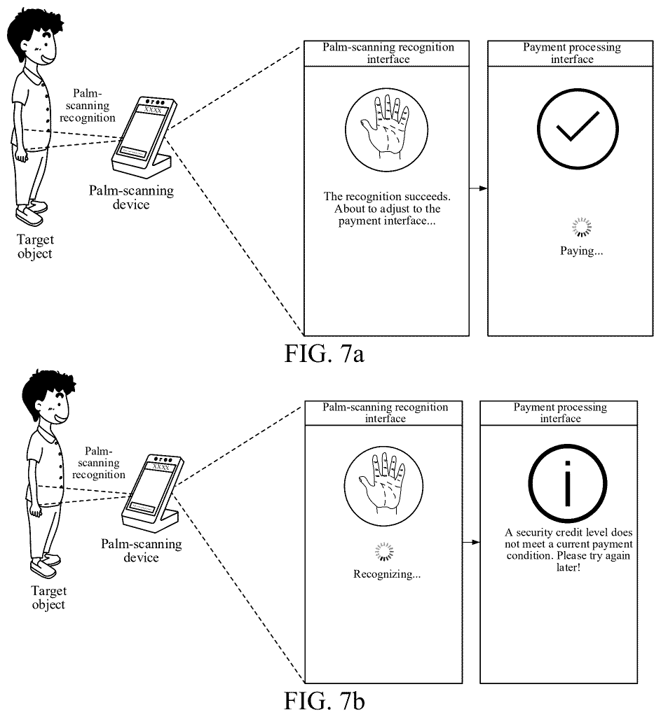

FIG. 7a is a schematic flowchart of a palm-scanning payment scenario according to an aspect of this disclosure. As shown in FIG. 7a, a preset object may perform palm-scanning recognition in a payment scenario, and invoke a palm-scanning device to collect palm data of the preset object, display the palm data in a palm-scanning recognition interface, and perform recognition on the palm data. If recognition succeeds, and a payment amount corresponding to a second credit indicator of the preset object is greater than or equal to an asset amount that requests to be processed in a current payment scenario, a payment processing interface is displayed, and a payment service is invoked to perform payment processing on an asset corresponding to the asset amount. FIG. 7b is a schematic flowchart of another palm-scanning payment scenario according to an aspect of this disclosure. As shown in FIG. 7b, a preset object may perform palm recognition in a payment scenario. If payment amount corresponding to a second credit indicator of the preset object is less than an asset amount requested to be processed in the current payment scenario, prompt information is outputted. For example, the prompt information includes: your security credit level does not meet a current payment condition. Please try again later!! Subsequently, the second credit indicator may be increased in another authenticatable service scenario, and then payment is performed. In this manner, in a payment scenario, a risk control policy may be flexibly adjusted with reference to a level of a security credit level indicated by a credit indicator of a user, thereby ensuring reliability and security of a related service processing process.

In the aspects of this disclosure, different palm-scanning devices need to perform scenario configuration for different service scenarios, so that the user completes identity registration in a corresponding configured service scenario (for example, a palm-scanning identity verification scenario and a payment scenarios). Subsequently, the user may perform related service processing operations such as door opening and payment in the service scenario. In this disclosure, when a trusted user performs scenario registration, and with reference to a refined risk control policy that is continuously adjusted, gradual verification and confidence escalation are performed on palm scanning of the user, thereby gradually improving experience of the user in various service scenarios while ensuring security.

The method of the aspects of this disclosure is described above. To facilitate better implementation of the foregoing solution of the aspects of this disclosure, the apparatus of the aspects of this disclosure is correspondingly provided below. Next, in conjunction with the data processing solution provided in the aspects of this disclosure above, the relevant apparatus of the aspects of this disclosure is described accordingly.

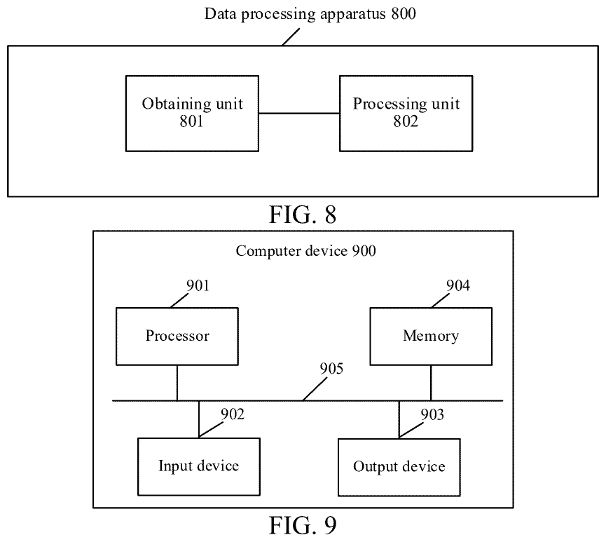

FIG. 8 is a schematic structural diagram of a data processing apparatus according to an aspect of this disclosure. As shown in FIG. 8, the data processing apparatus 800 may be applied to a computer device (for example, a terminal device or a server) in the foregoing aspects. Specifically, the data processing apparatus 800 may be a computer program (including program code) running in a computer device. For example, the data processing apparatus 800 is an application software. The data processing apparatus 800 may be configured to perform the corresponding operations in the data processing method provided in the aspects of this disclosure. During specific implementation, the data processing apparatus 800 may specifically include:
an obtaining unit 801, configured to obtain biological recognition data collected for a preset object in a service scenario; and
a processing unit 802, configured to perform identity recognition on the preset object based on the biological recognition data, to obtain a recognition result of the preset object.

The processing unit 802 is further configured to: obtain a first credit indicator in the service scenario corresponding to the preset object, and perform level adjustment on the first credit indicator based on the recognition result, to obtain a second credit indicator,
the second credit indicator being different from the first credit indicator, and in the service scenario, a risk control policy associated with the second credit indicator being different from a risk control policy associated with the first credit indicator.

In a possible implementation, the processing unit 802 performs level adjustment on the first credit indicator based on the recognition result, to obtain a second credit indicator, and is configured to perform the following operations:
obtaining scenario configuration information of the service scenario, the scenario configuration information including a security verification level of the service scenario; and
performing level improvement on the first credit indicator in a first adjustment manner if the security verification level of the service scenario meets a level adjustment condition and the recognition result indicates that the recognition succeeds, to obtain the second credit indicator.

In a possible implementation, the recognition result includes that the recognition succeeds or the recognition fails. The processing unit 802 is further configured to perform one of the following:
performing level lowering on the first credit indicator in a second adjustment manner if the security verification level of the service scenario does not meet the level adjustment condition or the recognition result indicates that the recognition fails, to obtain a third credit indicator;
performing level keeping on the first credit indicator if the security verification level of the service scenario meets the level adjustment condition or the recognition result indicates that the recognition fails; and
performing level keeping on the first credit indicator if the security verification level of the service scenario does not meet the level adjustment condition and the recognition result indicates that the recognition succeeds.

In a possible implementation, the processing unit 802 performs level adjustment on the first credit indicator based on the recognition result, to obtain a second credit indicator, and is configured to perform the following operations:
obtaining historical service data of the preset object if the security verification level of the service scenario does not meet the level adjustment condition, and training a level recognition model through the historical service data;
invoking a trained level recognition model to perform level recognition on the preset object, to obtain a security credit level of the preset object; and
performing the level adjustment on the first credit indicator based on the security credit level of the preset object and the recognition result, to obtain the second credit indicator.

In a possible implementation, after performing identity recognition on the preset object based on the biological recognition data, to obtain a recognition result of the preset object, the processing unit 802 is further configured to perform the following operations:
outputting a prompt interface if the recognition result indicates that the recognition succeeds, the prompt interface including a prompt area and an adjustment control, the prompt area being configured to prompt the preset object to permit or not permit the level adjustment on the first credit indicator, and the adjustment control being configured to receive a confirmation operation for the level adjustment on the first credit indicator; and
triggering, in response to a permission confirmation operation triggered in the prompt area, the operation of obtaining the first credit indicator in the service scenario corresponding to the preset object, and performing the level adjustment on the first credit indicator based on the recognition result, to obtain the second credit indicator.

In a possible implementation, the level adjustment includes any one or more of level lowering, level improvement, and level keeping. The adjustment control includes a first control, a second control, and a third control, the first control being configured to receive a confirmation operation for the level improvement, the second control being configured to receive a confirmation operation for the level lowering, and the third control being configured to receive a confirmation operation for the level keeping.

The processing unit 802 is further configured to perform any one of the following operations:
adjusting the first credit indicator to the second credit indicator in response to a permission confirmation operation triggered for the first control in the prompt area when the recognition result indicates that the recognition succeeds;
lowering the first credit indicator to the third credit indicator in response to a permission confirmation operation triggered for the second control in the prompt area when the recognition result indicates that the recognition fails; and
performing the level keeping on the first credit indicator in response to a permission confirmation operation triggered for the third control in the prompt area when the recognition result indicates that the recognition succeeds or fails.

In a possible implementation, the processing unit 802 performs identity recognition on the preset object based on the biological recognition data, to obtain a recognition result of the preset object, and is configured to perform the following operations:
performing feature extraction on the biological recognition data, to obtain a biological feature of the preset object;
obtaining registration data of the preset object, the registration data being generated after the preset object successfully performs identity registration in the service scenario, and the registration data including a registration feature; and
performing the identity recognition on the preset object based on the biological feature of the preset object and the registration feature of the preset object, to obtain the recognition result of the preset object.

In a possible implementation, the biological recognition data includes palm data. The processing unit 802 performs feature extraction on the biological recognition data, to obtain a biological feature of the preset object, and is configured to perform the following operations:
performing palm vein feature extraction on the palm data, to obtain a palm vein feature of the preset object;
performing palm print feature extraction on the palm data, to obtain a palm print feature of the preset object; and
performing feature fusion on the palm print feature and the palm vein feature, to obtain the biological feature of the preset object,
the feature fusion including at least any one of feature weighting, feature alignment, or feature calculation.

In a possible implementation, the obtaining unit 801 obtains biological recognition data collected for a preset object in a service scenario, and is configured to perform the following operations:
invoking a collection device to collect biological streaming media data of the preset object, the biological streaming media data including a plurality of biological images collected for the preset object; and
performing selection on the plurality of biological images based on a preset selection condition, to obtain the biological recognition data of the preset object,
the preset selection condition including any one or more of an image size, a capture angle, an image contrast, an image brightness, and a definition.

In a possible implementation, the service scenario is a payment scenario, a risk control policy in the payment scenario being configured for indicating that one credit indicator corresponds to one payment amount.

After performing level adjustment on the preset object from the first credit indicator based on the recognition result, to obtain a second credit indicator, the processing unit 802 is further configured to perform the following operations:
detecting an asset amount requested to be processed in the payment scenario;
invoking, if the payment amount corresponding to the second credit indicator is greater than or equal to the asset amount requested to be processed, a payment service to perform transfer on an asset corresponding to the asset amount; and
outputting prompt information if the payment amount corresponding to the second credit indicator is less than the asset amount requested to be processed, the prompt information being configured for triggering the level adjustment on the second credit indicator of the preset object, to cause a payment amount corresponding to the second credit indicator after the level adjustment to be greater than or equal to the asset amount requested to be processed.

In a possible implementation, the first credit indicator is a credit indicator allocated to the preset object after the preset object completes the identity registration in the service scenario. The service scenario is a payment scenario. before the processing unit 802 obtains biological recognition data collected for a preset object in a service scenario, the method further includes:
obtaining scenario configuration information of the payment scenario in response to an identity registration request of the preset object in the payment scenario, the scenario configuration information including a security verification level of the payment scenario;
allocating the credit indicator to the preset object in the payment scenario based on the security verification level of the payment scenario if the security verification level of the payment scenario meets the level adjustment condition; and
determining a reference credit indicator as the credit indicator allocated to the preset object in the payment scenario if the security verification level of the payment scenario does not meet the level adjustment condition.

In the aspects of this disclosure, for specific implementation of operations performed by the units of the data processing apparatus and corresponding effects that can be generated, reference may be made to related descriptions of the foregoing aspects. Details are not described herein again.

FIG. 9 is a schematic structural diagram of a computer device according to an aspect of this disclosure. The computer device 900 is configured to perform the operations performed by the terminal device or the server in the foregoing method aspects. The computer device 900 includes processing circuitry, such as one or more processors 901, one or more input devices 902, one or more output devices 903 and a memory 904. The foregoing processor 901, the input device 902, the output device 903, and the memory 904 are connected through a bus 905. Specifically, the memory 904 is configured to store a computer program, the computer program including a program instruction. The processor 901 is configured to invoke the program instruction stored in the memory 904 to perform the following operations:
obtaining biological recognition data collected for a preset object in a service scenario;
performing identity recognition on the preset object based on the biological recognition data, to obtain a recognition result of the preset object; and
obtaining a first credit indicator in the service scenario corresponding to the preset object, and performing level adjustment on the first credit indicator based on the recognition result, to obtain a second credit indicator,
the second credit indicator being different from the first credit indicator, and in the service scenario, a risk control policy associated with the second credit indicator being different from a risk control policy associated with the first credit indicator.

In a possible implementation, the processor 901 performs level adjustment on the first credit indicator based on the recognition result, to obtain a second credit indicator, and is configured to perform the following operations:
obtaining scenario configuration information of the service scenario, the scenario configuration information including a security verification level of the service scenario; and
performing level improvement on the first credit indicator in a first adjustment manner if the security verification level of the service scenario meets a level adjustment condition and the recognition result indicates that the recognition succeeds, to obtain the second credit indicator.

In a possible implementation, the recognition result includes that the recognition succeeds or the recognition fails. The processor 901 is further configured to perform one of the following:
performing level lowering on the first credit indicator in a second adjustment manner if the security verification level of the service scenario does not meet the level adjustment condition or the recognition result indicates that the recognition fails, to obtain a third credit indicator;
performing level keeping on the first credit indicator if the security verification level of the service scenario meets the level adjustment condition or the recognition result indicates that the recognition fails; and
performing level keeping on the first credit indicator if the security verification level of the service scenario does not meet the level adjustment condition and the recognition result indicates that the recognition succeeds.

In a possible implementation, the processor 901 performs level adjustment on the first credit indicator based on the recognition result, to obtain a second credit indicator, and is configured to perform the following operations:
obtaining historical service data of the preset object if the security verification level of the service scenario does not meet the level adjustment condition, and training a level recognition model through the historical service data;
invoking a trained level recognition model to perform level recognition on the preset object, to obtain a security credit level of the preset object; and
performing the level adjustment on the first credit indicator based on the security credit level of the preset object and the recognition result, to obtain the second credit indicator.

In a possible implementation, after performing identity recognition on the preset object based on the biological recognition data, to obtain a recognition result of the preset object, the processor 901 is further configured to perform the following operations:
outputting a prompt interface if the recognition result indicates that the recognition succeeds, the prompt interface including a prompt area and an adjustment control, the prompt area being configured to prompt the preset object to permit or not permit the level adjustment on the first credit indicator, and the adjustment control being configured to receive a confirmation operation for the level adjustment on the first credit indicator; and
triggering, in response to a permission confirmation operation triggered in the prompt area, the operation of obtaining the first credit indicator in the service scenario corresponding to the preset object, and performing the level adjustment on the first credit indicator based on the recognition result, to obtain the second credit indicator.

In a possible implementation, the level adjustment includes any one or more of level lowering, level improvement, and level keeping. The adjustment control includes a first control, a second control, and a third control, the first control being configured to receive a confirmation operation for the level improvement, the second control being configured to receive a confirmation operation for the level lowering, and the third control being configured to receive a confirmation operation for the level keeping.

The processor 901 is further configured to perform any one of the following operations:
adjusting the first credit indicator to the second credit indicator in response to a permission confirmation operation triggered for the first control in the prompt area when the recognition result indicates that the recognition succeeds;
lowering the first credit indicator to the third credit indicator in response to a permission confirmation operation triggered for the second control in the prompt area when the recognition result indicates that the recognition fails; and
performing the level keeping on the first credit indicator in response to a permission confirmation operation triggered for the third control in the prompt area when the recognition result indicates that the recognition succeeds or fails.

In a possible implementation, the processor 901 performs identity recognition on the preset object based on the biological recognition data, to obtain a recognition result of the preset object, and is configured to perform the following operations:
performing feature extraction on the biological recognition data, to obtain a biological feature of the preset object;
obtaining registration data of the preset object, the registration data being generated after the preset object successfully performs identity registration in the service scenario, and the registration data including a registration feature; and
performing the identity recognition on the preset object based on the biological feature of the preset object and the registration feature of the preset object, to obtain the recognition result of the preset object.

In a possible implementation, the biological recognition data includes palm data. The processor 901 performs feature extraction on the biological recognition data, to obtain a biological feature of the preset object, and is configured to perform the following operations:
performing palm vein feature extraction on the palm data, to obtain a palm vein feature of the preset object;
performing palm print feature extraction on the palm data, to obtain a palm print feature of the preset object; and
performing feature fusion on the palm print feature and the palm vein feature, to obtain the biological feature of the preset object,
the feature fusion including at least any one of feature weighting, feature alignment, or feature calculation.

In a possible implementation, the processor 901 obtains biological recognition data collected for a preset object in a service scenario, and is configured to perform the following operations:
invoking a collection device to collect biological streaming media data of the preset object, the biological streaming media data including a plurality of biological images collected for the preset object; and
performing selection on the plurality of biological images based on a preset selection condition, to obtain the biological recognition data of the preset object,
the preset selection condition including any one or more of an image size, a capture angle, an image contrast, an image brightness, and a definition.

In a possible implementation, the service scenario is a payment scenario, a risk control policy in the payment scenario being configured for indicating that one credit indicator corresponds to one payment amount.

After performing level adjustment on the preset object from the first credit indicator based on the recognition result, to obtain a second credit indicator, the processor 901 is further configured to perform the following operations:
detecting an asset amount requested to be processed in the payment scenario;
invoking, if the payment amount corresponding to the second credit indicator is greater than or equal to the asset amount requested to be processed, a payment service to perform transfer on an asset corresponding to the asset amount; and
outputting prompt information if the payment amount corresponding to the second credit indicator is less than the asset amount requested to be processed, the prompt information being configured for triggering the level adjustment on the second credit indicator of the preset object, to cause a payment amount corresponding to the second credit indicator after the level adjustment to be greater than or equal to the asset amount requested to be processed.

In a possible implementation, the first credit indicator is a credit indicator allocated to the preset object after the preset object completes the identity registration in the service scenario. The service scenario is a payment scenario. before the processor 901 obtains biological recognition data collected for a preset object in a service scenario, the method further includes:
obtaining scenario configuration information of the payment scenario in response to an identity registration request of the preset object in the payment scenario, the scenario configuration information including a security verification level of the payment scenario;
allocating the credit indicator to the preset object in the payment scenario based on the security verification level of the payment scenario if the security verification level of the payment scenario meets the level adjustment condition; and
determining a reference credit indicator as the credit indicator allocated to the preset object in the payment scenario if the security verification level of the payment scenario does not meet the level adjustment condition.

In this aspect of this disclosure, for specific implementation of each operation performed by the processor of the computer device and a corresponding effect that can be generated, reference may be made to related descriptions in the foregoing aspects. Details are not described herein again.

In addition, an aspect of this disclosure further provides a computer-readable storage medium, such as a non-transitory computer-readable storage medium, having a computer program stored therein, and the computer program includes a program instruction. When the foregoing program instruction is executed by a processor, the method in the corresponding aspects described above can be performed. Therefore, details are not described herein. For technical details not disclosed in the aspect of the computer storage medium of this disclosure, reference may be made to the description of the method aspects of this disclosure. In an example, the program instruction may be deployed on one computer device, or executed on a plurality of computer devices located at one location, or executed on a plurality of computer devices distributed at a plurality of locations and connected by a communication network.

According to an aspect of this disclosure, an aspect of this disclosure further provides a computer program product or a computer program, the computer program product or the computer program including a computer instruction, the computer instruction being stored in a computer-readable storage medium. A processor of a computer device reads the computer instruction from the computer-readable storage medium, and the processor executes the computer instruction, so that the computer device can perform the method in the corresponding aspects described above. Therefore, details are not described herein.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is disclosed above is merely examples of aspects of this disclosure, and certainly is not intended to limit the scope of this disclosure. Therefore, equivalent variations made in accordance with this disclosure still fall within the scope of this disclosure.

What is claimed is:

1. A computer-implemented method for managing a permission level of a user in a service scenario, comprising:
acquiring biometric data of the user, the biometric data being collected in the service scenario;
performing identity recognition on the user based on the biometric data to obtain a recognition result;
obtaining a first permission level associated with the user in the service scenario; and
adjusting the first permission level based on the recognition result to generate a second permission level, wherein
the second permission level is different from the first permission level, and
a second permission limit associated with the second permission level is different from a first permission limit associated with the first permission level.

2. The method according to claim 1, wherein the adjusting comprises:
obtaining scenario configuration information that includes a security verification level of the service scenario; and
increasing the first permission level in a first adjustment manner based on the security verification level of the service scenario meeting a level adjustment condition and the recognition result indicating that the recognition succeeds.

3. The method according to claim 2, wherein the adjusting comprises:
decreasing the first permission level in a second adjustment manner when at least one of the security verification level of the service scenario does not meet the level adjustment condition or the recognition result indicates that the recognition fails.

4. The method according to claim 2, wherein the first permission level is not adjusted when at least one of the security verification level of the service scenario does not meet the level adjustment condition or the recognition result indicates that the recognition fails.

5. The method according to claim 2, wherein the performing the level adjustment comprises:
obtaining historical service data of the user based on the security verification level not meeting the level adjustment condition;
performing security level recognition using a level recognition model and the historical service data to determine a security level of the user; and
adjusting the first permission level based on the determined security level of the user and the recognition result to obtain the second permission level.

6. The method according to claim 1, further comprising:
outputting a confirmation interface when the recognition result indicates success, the confirmation interface including an adjustment control interface configured to receive a user input that indicates whether the first permission level is to be adjusted.

7. The method according to claim 6, wherein the adjustment control interface comprises:
a first control element configured to indicate the first permission level is to be increased,
a second control element configured to indicate the first permission level is to be decreased, and
a third control element configured to indicate the first permission level is not to be adjusted.

8. The method according to claim 1, wherein the performing the identity recognition comprises:
extracting a biometric feature of the user from the biometric data;
obtaining registration data including a stored registration feature of the user; and
comparing the biometric feature and the registration feature to determine the recognition result of the user.

9. The method according to claim 8, wherein the biometric data includes palm data, and the extracting comprises:
extracting a palm vein feature;
extracting a palm print feature; and
performing feature fusion on the palm print feature and the palm vein feature based on at least one of feature weighting, feature alignment, or feature calculation.

10. The method according to claim 1, wherein the acquiring the biometric data comprises:
controlling a collection device to collect a stream of biometric images of the user; and
selecting a biometric image from the biometric images based on a preset selection condition.

11. The method according to claim 1, wherein
the service scenario is a payment scenario,
the second permission limit defines a maximum permissible payment amount associated with the second permission level, and
the method further comprises:
detecting a requested payment amount;
invoking a payment service based on the maximum permissible payment amount associated with the second permission level being greater than or equal to the requested amount; and
outputting a prompt to initiate permission level adjustment when the maximum permissible payment amount associated with the second permission level is less than the requested amount.

12. A data processing apparatus, comprising:
processing circuitry configured to:
acquire biometric data of a user, the biometric data being collected in a service scenario;
perform identity recognition on the user based on the biometric data to obtain a recognition result;
obtain a first permission level associated with the user in the service scenario; and
adjust the first permission level based on the recognition result to generate a second permission level, wherein
the second permission level is different from the first permission level, and
a second permission limit associated with the second permission level is different from a first permission limit associated with the first permission level.

13. The data processing apparatus according to claim 12, wherein the processing circuitry configured to:
obtain scenario configuration information that includes a security verification level of the service scenario; and
increase the first permission level in a first adjustment manner based on the security verification level of the service scenario meeting a level adjustment condition and the recognition result indicating that the recognition succeeds.

14. The data processing apparatus according to claim 13, wherein the processing circuitry configured to:
decrease the first permission level in a second adjustment manner when at least one of the security verification level of the service scenario does not meet the level adjustment condition or the recognition result indicates that the recognition fails.

15. The data processing apparatus according to claim 13, wherein the first permission level is not adjusted when at least one of the security verification level of the service scenario does not meet the level adjustment condition or the recognition result indicates that the recognition fails.

16. The data processing apparatus according to claim 13, wherein the processing circuitry configured to:
obtain historical service data of the user based on the security verification level not meeting the level adjustment condition;
perform security level recognition using a level recognition model and the historical service data to determine a security level of the user; and
adjust the first permission level based on the determined security level of the user and the recognition result to obtain the second permission level.

17. The data processing apparatus according to claim 12, wherein the processing circuitry configured to:
output a confirmation interface when the recognition result indicates success, the confirmation interface including an adjustment control interface configured to receive a user input that indicates whether the first permission level is to be adjusted.

18. The data processing apparatus according to claim 17, wherein the adjustment control interface comprises:
a first control element configured to indicate the first permission level is to be increased,
a second control element configured to indicate the first permission level is to be decreased, and
a third control element configured to indicate the first permission level is not to be adjusted.

19. The data processing apparatus according to claim 12, wherein the processing circuitry configured to:
extract a biometric feature of the user from the biometric data;
obtain registration data including a stored registration feature of the user; and
compare the biometric feature and the registration feature to determine the recognition result of the user.

20. A non-transitory computer-readable storage medium storing instructions which when executed, cause at least one processor to:
acquire biometric data of a user, the biometric data being collected in a service scenario;
perform identity recognition on the user based on the biometric data to obtain a recognition result;
obtain a first permission level associated with the user in the service scenario; and
adjust the first permission level based on the recognition result to generate a second permission level, wherein
the second permission level is different from the first permission level, and
a second permission limit associated with the second permission level is different from a first permission limit associated with the first permission level.
